(19) United States
(12) Patent Application Publication
(10) Pub. No.: US 2009/0067175 A1
(43) Pub. Date: Mar. 12, 2009

(54) LENS FOR USE WITH A LIGHT-EMITTING ELEMENT AND LIGHT SOURCE DEVICE INCLUDING THE LENS

(75) Inventors: Liang-Tang Chen, Taiapei Hsien (TW); Ming-Li Chang, Taipei Hsien (TW); Chou-Chih Yin, Taipei Hsien (TW)

Correspondence Address: DARBY & DARBY P.C., P.O. BOX 770, Church Street Station, New York, NY, 10008-0770, US

(73) Assignee: Bright LED Electronics Corp., Taipei Hsien (TW)

(21) Appl. No.: 12/271,468

(22) Filed: Nov. 14, 2008

Related U.S. Application Data
(63) Continuation-in-part of application No. 11/619,704, filed on Jan. 4, 2007.

(30) Foreign Application Priority Data
Nov. 15, 2007 (TW) 096143213

(51) Int. Cl. F21V 14/00

(52) U.S. Cl. 362/255

(57) ABSTRACT

A lens for use with a light-emitting element includes a lens body that has a bottom surface for receiving light from the light-emitting element, a top surface opposite to the bottom surface along an optical axis, a peripheral surface extending and converging from the bottom surface to the top surface such that a projection of a perimeter of the top surface onto a plane of the bottom surface is surrounded by a perimeter of the bottom surface, and a textured structure formed on the top surface for scattering light that exits the top surface at angles relative to the optical axis.

### CROSS-REFERENCE TO RELATED APPLICATION

This application is a continuation-in-part of pending U.S. patent application Ser. No. 11/619,704, filed on Jan. 4, 2007, and claims priority of Taiwanese Application No. 096143213, filed on Nov. 15, 2007.

### BACKGROUND OF THE INVENTION

1. Field of the Invention

The invention relates to a lens, more particularly to a lens for use with a light-emitting element. The invention also relates to a light source device including the lens.

2. Description of the Related Art

It is conventional to use a cold cathode fluorescent lamp as a light source in a direct-type backlight module. However, the cold cathode fluorescent lamp has drawbacks of a relatively large size, large power consumption, and use of mercury that is detrimental to the environment. Therefore, it has become a trend to substitute the cold cathode fluorescent lamp with a light-emitting diode, which has advantages such as a relatively small size, a high light-emitting efficiency, and a relatively long service life.

Referring to FIG. 1, a light intensity of a conventional light-emitting diode is decreased as an angle relative to an optical axis normal to a light-exiting surface is increased. Therefore, the distribution of the light intensity on the light-exiting surface of the conventional light-emitting diode is relatively uneven.

### SUMMARY OF THE INVENTION

Therefore, an object of the present invention is to provide a lens for use with a light-emitting element so as to obtain a relatively even distribution of a light intensity.

Another object of the present invention is to provide a light source device including the lens.

According to one aspect of this invention, a lens for use with a light-emitting element includes a lens body that has a bottom surface for receiving light from the light-emitting element, a top surface opposite to the bottom surface along an optical axis, a peripheral surface extending and converging from the bottom surface to the top surface such that a projection of a perimeter of the top surface onto a plane of the bottom surface is surrounded by a perimeter of the bottom surface, and a textured structure formed on the top surface for scattering light that exits the top surface at angles relative to the optical axis.

According to another aspect of this invention, alight source device includes a base, a light-emitting element, and a lens. The light-emitting element is mounted on the base. The lens is mounted on the base, and includes a lens body that has a bottom surface for receiving light from the light-emitting element, a top surface opposite to the bottom surface along an optical axis, a peripheral surface extending and converging from the bottom surface to the top surface such that a projection of a perimeter of the top surface onto a plane of the bottom surface is surrounded by a perimeter of the bottom surface, and a textured structure formed on the top surface for scattering light that exits the top surface at angles relative to the optical axis.

### BRIEF DESCRIPTION OF THE DRAWINGS

Other features and advantages of the present invention will become apparent in the following detailed description of the preferred embodiment with reference to the accompanying drawings, of which;

FIG. 1 is a polar plot showing a light intensity distribution of a conventional light-emitting diode;

FIG. 2 is a sectional view of a preferred embodiment of a lens according to this invention for use in a light source device;

FIG. 3 is a top view of the preferred embodiment;

FIG. 4 is a schematic view illustrating a textured structure formed on the preferred embodiment;

FIG. 5 is a schematic view illustrating another textured structure formed on the preferred embodiment;

FIG. 6 is a rectangular coordinate plot showing a light intensity distribution achieved with the use of the preferred embodiment;

FIG. 7 is a polar plot showing a light intensity distribution achieved with the use of the preferred embodiment;

FIG. 8 is a flow chart of a method for making a light source device of the preferred embodiment;

FIG. 9 is a schematic view illustrating the method for making the light source device of the preferred embodiment;

FIG. 10 is a flow chart of another method for making the light source device of the preferred embodiment;

FIG. 11 is a sectional view of a lens cover used in the method of FIG. 10;

FIG. 12 is a flow chart of still another method for making the light source device of the preferred embodiment; and

FIGS. 13-15 are schematic views showing various contours of a top surface of a lens body of the lens of the preferred embodiment.

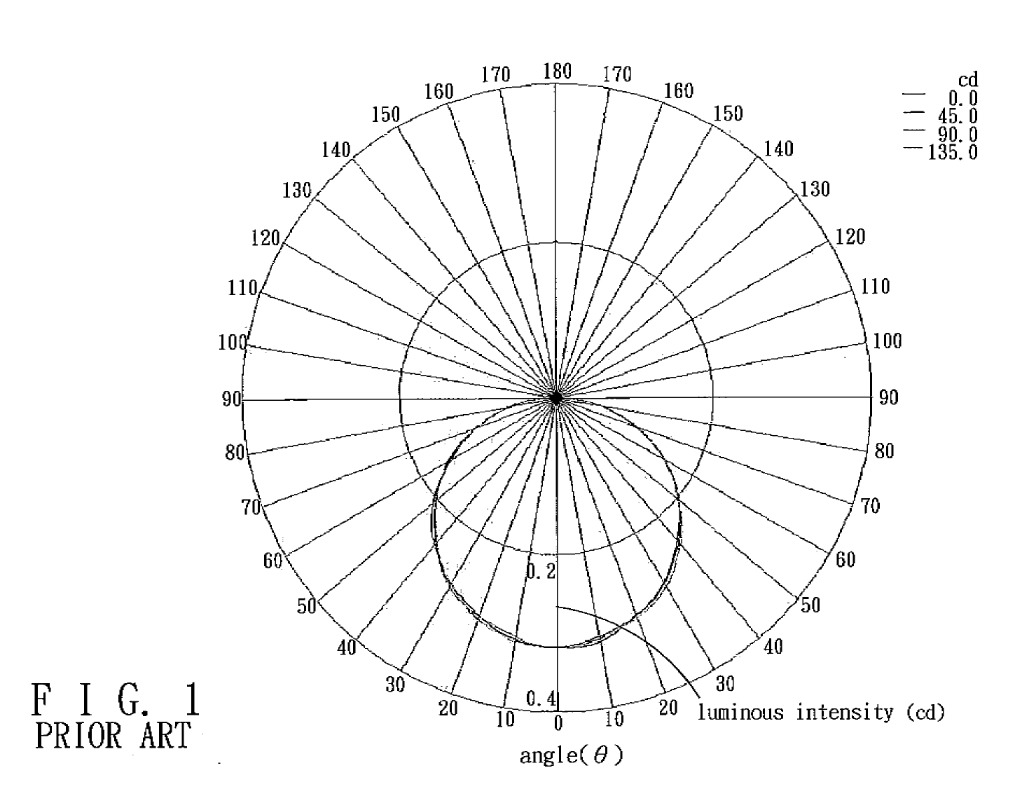

### DETAILED DESCRIPTION OF THE PREFERRED EMBODIMENT

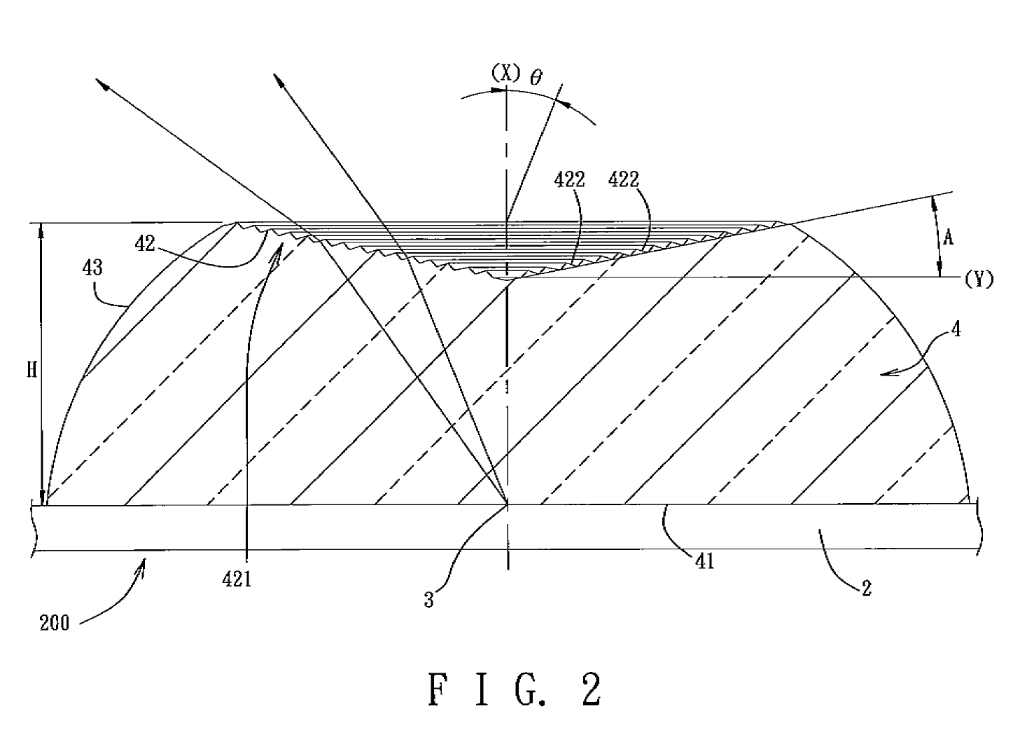

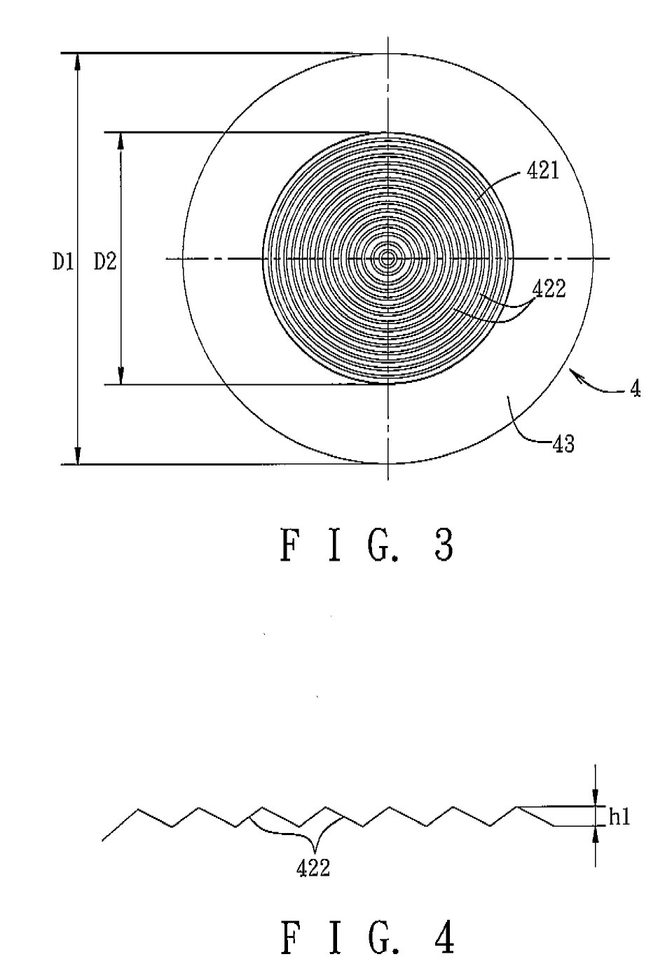

Referring to FIGS. 2, 3, 4, and 5, the preferred embodiment of a lens 4 according to this invention is used in a light source device 200, which includes a base 2, a light-emitting element 3 mounted on the base 2, and the lens 4 mounted on the base 2.

The base 2 can be any base commonly used in the art of packaging a light-emitting semiconductor component, and examples thereof include a plastic coated metal lead frame, a vertical lead frame, a planar lead frame, a piranha lead frame, or the like. The light-emitting element 3 is mounted by die-attaching, wire-bonding, and packaging. The light-emitting element 3 used in the preferred embodiment is a light-emitting diode.

The lens 4 is mounted on the base 2 and encapsulates the light-emitting element 3. The lens 4 can be made by injection molding of a thermoplastic polymer, such as polymethyl methacrylate, polycarbonate, or the like, by infusion of thermosetting plastic, such as epoxy resin, silicone, or the like, or by molding of transparent glass. The refractive index of the lens 4 preferably ranges from 1.2 to 1.8.

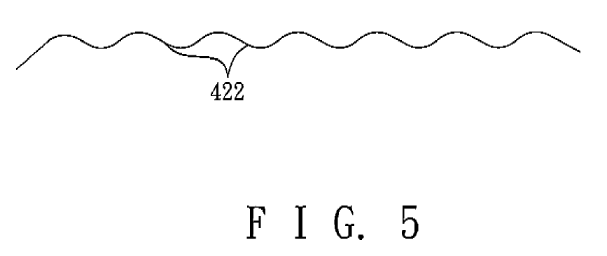

The lens 4 includes a lens body that has a bottom surface 41 contacted with the base 2 for receiving light from the light-emitting element 3, a top surface 42 opposite to the bottom surface 41 along an optical axis (X), a peripheral surface 43 extending and converging from the bottom surface 41 to the top surface 42 such that a projection of a perimeter of the top surface 42 onto a plane of the bottom surface 41 is surrounded by a perimeter of the bottom surface 41, and a textured structure 421 formed on the tops surface 42 for scattering light that exits the top surface 42 at angles relative to the optical axis (X). The textured structure 421 is a stepped structure, and includes a plurality of concentric annular steps 422. The stepped structure includes a plurality of prismatic steps (best shown in FIG. 4) or a plurality of wavy steps (best shown in FIG. 5). The steps 422 are coaxial with the optical axis (X) and increase in diameter in a direction away from the bottom surface 41. The peripheral surface 43 is a curved surface, and is a segment of a spherical surface in this embodiment.

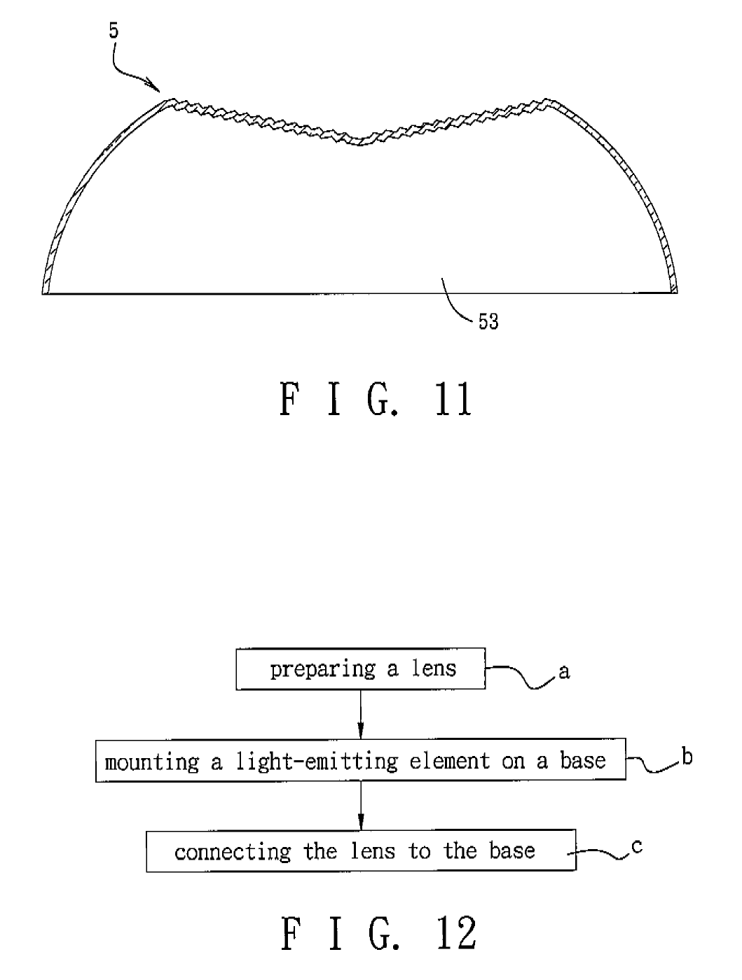

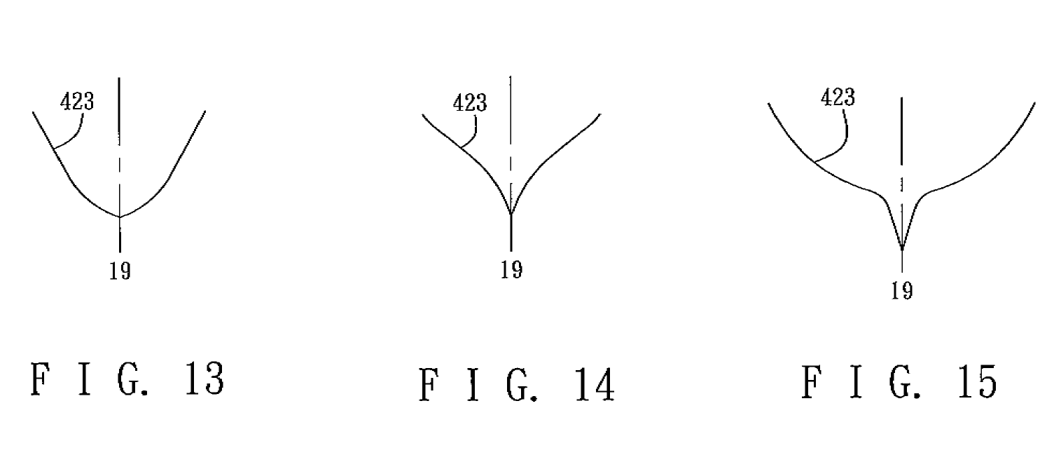

Referring to FIGS. 2, 13, 14, and 15, the top surface 42 is formed with a recess defined by a recess-defining surface 423, and the textured structure 421 is formed on the recess-defining surface 423. The recess-defining surface 423 preferably has a conical shape (see FIG. 2), a concave shape (see FIG. 13), a horn shape (see FIG. 14), or a bowl shape with a pointed indentation (see FIG. 15).

Referring again to FIGS. 2, 3, and 4, the lens 4 illustrated in the preferred embodiment has the following dimensions: The diameter (D2) of the perimeter of the top surface 42 is 3.04 mm, the diameter (D1) of the perimeter of the bottom surface 41 is 4.97 mm, and the height (H) of the lens 4 is 1.5 mm. The peripheral surface 43 is a segment of a spherical surface having a curvature radius of 1.95 mm. The height of each of the steps 422 is 0.03 mm. An angle (A) defined by the recess-defining surface 423 and a horizontal line (Y) is, for example, 3.79°, 7.49°, or 11.16°. It should be noted that the aforesaid dimensions for the lens 4 can be varied according to specific requirements in use.

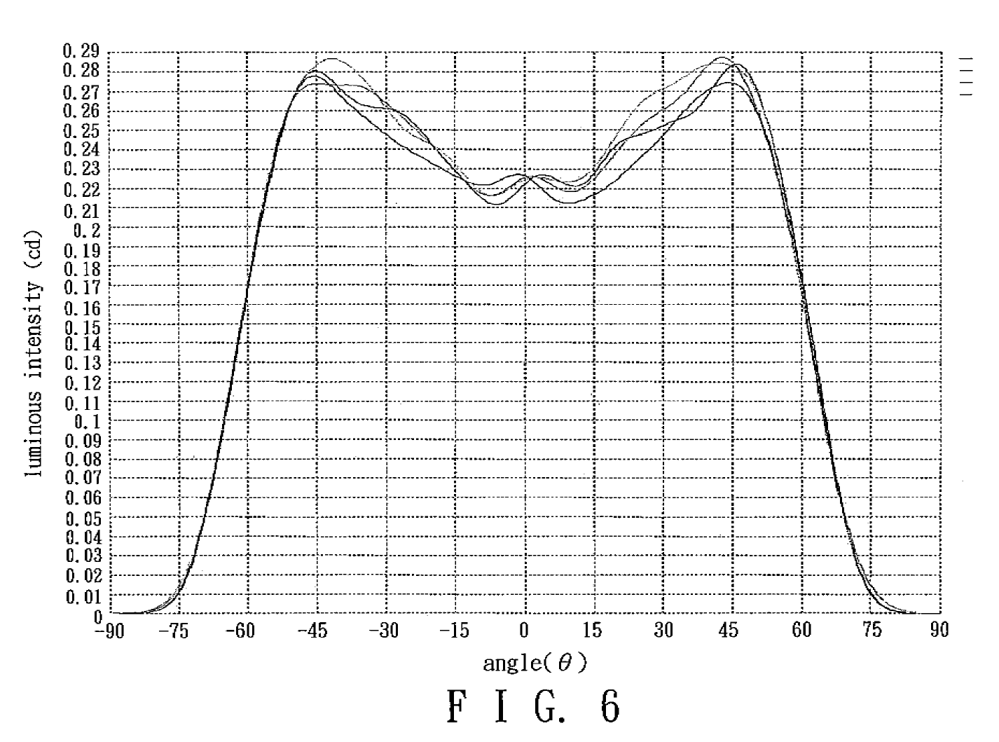

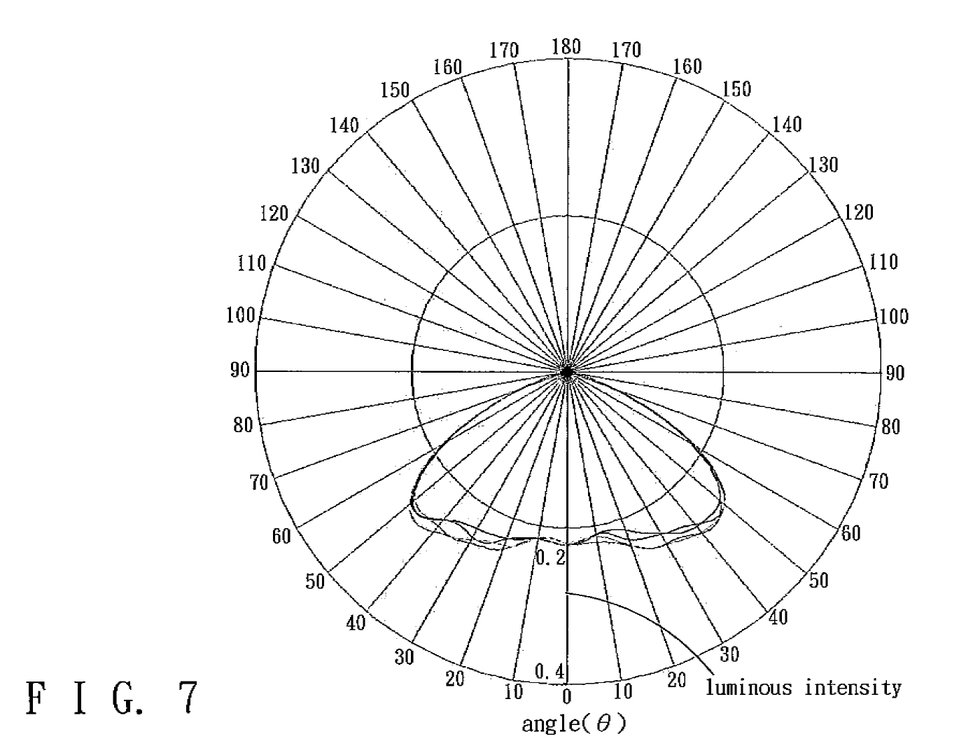

Referring to FIGS. 6 and 7, since the textured structure 421 formed on the top surface 42 scatters light that exits the top surface 42 at angles relative to the optical axis (X), the distribution of the light intensity on the top surface 42 of the lens 4 is relatively even.

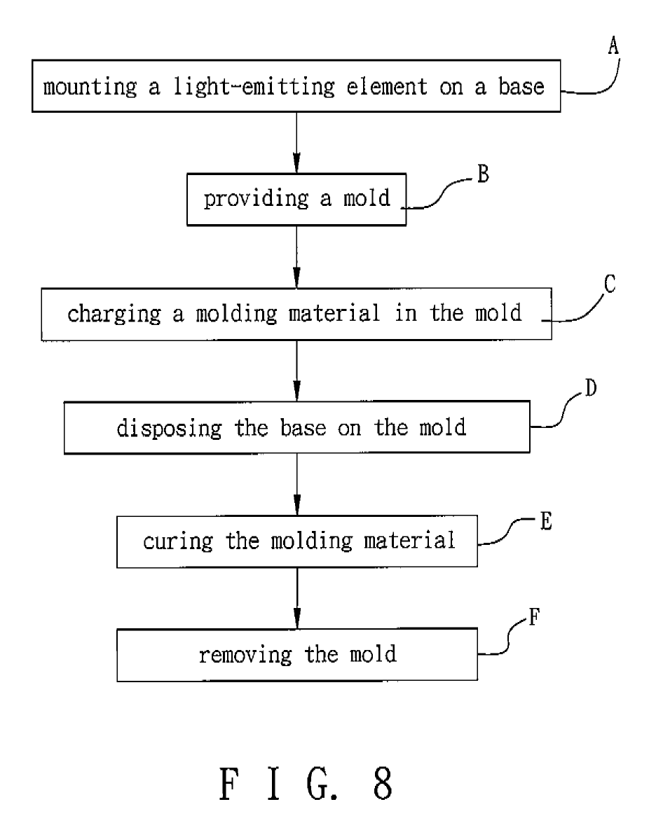

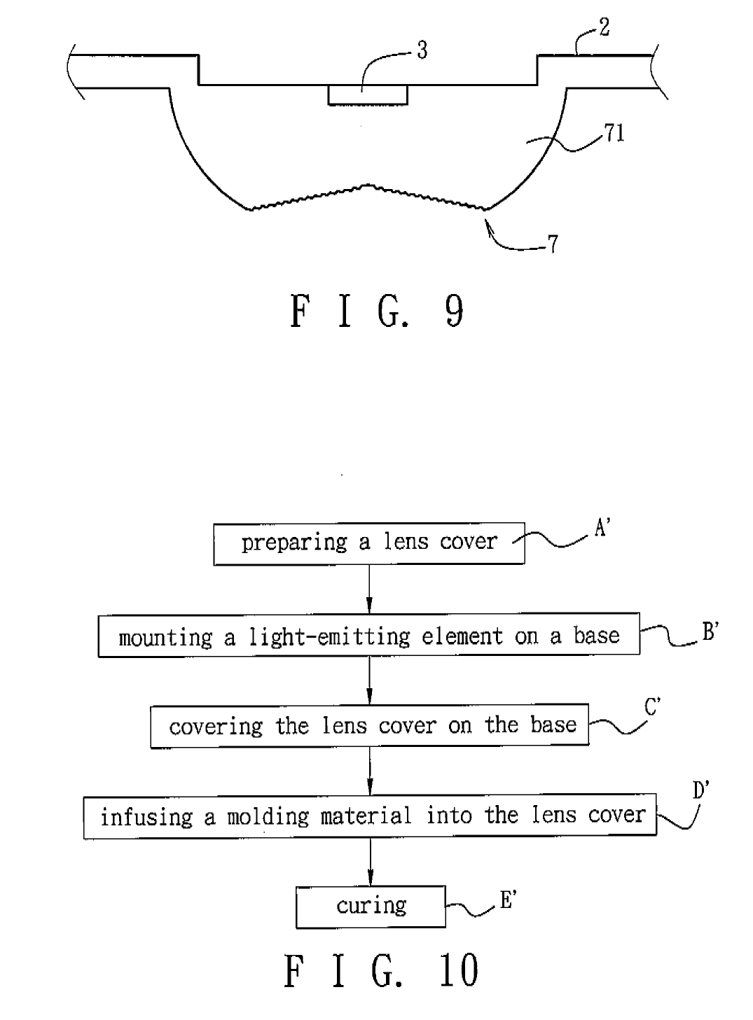

Referring to FIGS. 2, 8, and 9, the light source device 200 including the lens of the preferred embodiment can be made by the following steps:

A) mounting the light-emitting element 3 on the base 2 by die-attaching and wire-bonding;

B) providing a mold 7 defining a mold cavity 71 having a contour corresponding to that of the lens 4;

C) charging a molding material, such as thermosetting resin (for example, epoxy resin or silicone), into the mold cavity 71 of the mold 7;

D) disposing the base 2 together with the light-emitting element 3 on the mold 7 so that the light-emitting element 3 is embedded in the molding material;

E) curing the molding material by baking to form the lens 4; and

F) removing the mold 7 from the lens 4.

It should be noted that the molding material can be charged into the mold cavity 71 of the mold after disposing the base 2 together with the light-emitting element 3 on the mold 7.

Referring to FIGS. 10 and 11, alternatively, the light source device 200 including the lens 4 of the preferred embodiment can be made by the following steps:

A′) preparing a lens cover 5 defining a receiving space 51 having a contour corresponding to that of the lens 4;

B′) mounting the light-emitting element 3 on the base 2 by die-attaching and wire-bonding;

C′) covering the lens cover 5 on the base 2 so that the light-emitting element 3 is received in the receiving space 51 of the lens cover 5;

D′) infusing a molding material into the receiving space 51 of the lens cover 5; and

E′) curing the molding material by baking to form the lens 4.

Referring to FIG. 12, alternatively, the light source device 200 including the lens 4 of the preferred embodiment can be made by the following steps:

a) preparing the lens 4 made of thermoplastic polymer, thermosetting plastic, or glass;

b) mounting the light-emitting element 3 on the base 2 by die-attaching and wire-bonding; and

c) connecting the lens 4 to the base 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A lens for use with a light-emitting element, said lens comprising a lens body having
a bottom surface for receiving light from the light-emitting element,
a top surface opposite to said bottom surface along an optical axis,
a peripheral surface extending and converging from said bottom surface to said top surface such that a projection of a perimeter of said top surface onto a plane of said bottom surface is surrounded by a perimeter of said bottom surface, and
a textured structure formed on said top surface for scattering light that exits said top surface at angles relative to the optical axis,
wherein said textured structure is a stepped structure, and
wherein said top surface is formed with a recess defined by a recess-defining surface, and said textured structure is formed on said recess-defining surface.

2. The lens as claimed in claim 1, wherein said textured structure includes a plurality of concentric annular steps.

3. The lens as claimed in claim 1, wherein said recess-defining surface has one of a conical shape, a concave shape, a horn shape, and a bowl shape with a pointed indentation.

4. The lens as claimed in claim 2, wherein said steps are coaxial with the optical axis and increase in diameter in a direction away from said bottom surface.

5. The lens as claimed in claim 1, wherein said peripheral surface is a curved surface.

6. The lens as claimed in claim 1, wherein said peripheral surface is a segment of a spherical surface.

7. The lens as claimed in claim 1, wherein said stepped structure includes a plurality of prismatic steps.

8. The lens as claimed in claim 1, wherein said stepped structure includes a plurality of rounded steps.

9. A light source device comprising:
a base;
a light-emitting element mounted on said base; and
a lens mounted on said base and including a lens body that has
a bottom surface for receiving light from said light-emitting element,
a top surface opposite to said bottom surface along an optical axis,
a peripheral surface extending and converging from said bottom surface to said top surface such that a projection of a perimeter of said top surface onto a plane of said bottom surface is surrounded by a perimeter of said bottom surface, and
a textured structure formed on said top surface for scattering light that exits said top surface at angles relative to the optical axis,
wherein said textured structure is a stepped structure, and
wherein said top surface is formed with a recess defined by a recess-defining surface, and said textured structure is formed on said recess-defining surface.

10. The light source device as claimed in claim 9, wherein said textured structure includes a plurality of concentric annular steps.

11. The light source device as claimed in claim 9, wherein said recess-defining surface has one of a conical shape, a concave shape, a horn shape, and a bowl shape with a pointed indentation.

12. The light source device as claimed in claim 10, wherein said steps are coaxial with the optical axis and increase in diameter in a direction away from said bottom surface.

13. The light source device as claimed in claim 9, wherein said peripheral surface is a curved surface.

14. The light source device as claimed in claim 9, wherein said peripheral surface is a segment of a spherical surface.

15. The light source device as claimed in claim 9, wherein said stepped structure includes a plurality of prismatic steps.

16. The light source device as claimed in claim 9, wherein said stepped structure includes a plurality of wavy steps.
